(19) United States
(12) Patent Application Publication
(10) Pub. No.: US 2014/0310054 A1
(43) Pub. Date: Oct. 16, 2014

(54) METHOD AND SYSTEM FOR ASSESSING WORKFLOW COMPATIBILITY

(71) Applicant: XEROX CORPORATION, Norwalk, CT (US)

(72) Inventors: Andres Quiroz Hernandez, JR., Rochester, NY (US); Yasmine Charif, Rochester, NY (US)

(73) Assignee: XEROX Corporation, Norwalk, CT (US)

(21) Appl. No.: 13/863,594

(22) Filed: Apr. 16, 2013

(51) Int. Cl. G06Q 10/06

(52) U.S. Cl. CPC G06Q 10/0633
USPC 705/7.27

(57) ABSTRACT

Disclosed are a method and a system for comparing established workflows against a workflow pattern to determine their degree of compatibility with this workflow pattern. In the method and system, compatibility scores between established workflows and a workflow pattern can be determined. To determine the compatibility score between a workflow pattern, which comprises first tasks, and an established workflow, which comprises second tasks, equivalent tasks in the established workflow can be identified. Then, dependency matrices can be constructed for the first tasks in the workflow pattern and the equivalent tasks in the established workflow. These dependency matrices can be compared in order to identify any dependency relation matches in corresponding task pairs. Values can be assigned to the dependency relation matches and compatibility scores can be determined based on the sum of those values.

### BACKGROUND

The method and the system disclosed herein relate to business process management (BPM) and, more particularly, to a method and system for comparing workflows against a workflow pattern to determine their degree of compatibility in order to identify previously established workflows that can be used by a business process analyst in designing a new workflow, in refining an existing workflow, in integrating multiple workflow repositories (e.g., to eliminate duplicates), or in any other application that requires comparing one or more workflow patterns against a number of other workflows.

Business Process Management (BPM) is an essential part of modern business wherein complex interactions between human and software systems are streamlined and automated. BPM encompasses a wide range of activities, including abstracting user-submitted process requirements (i.e., user-submitted constraints) for a process model into defined tasks (i.e., defined services) and further incorporating those defined tasks into defined workflows. Oftentimes, however, a business process analyst that engages in workflow design has only a limited knowledge (e.g., a high level knowledge or partial knowledge) of the various different tasks (i.e., the different services) required for a workflow, of the implementation of such tasks and/or of the composability of such tasks. Thus, it would be advantageous if the business process analyst could find similar previously established workflows (i.e., previously designed workflows that included at least some of the same tasks), which can be used to aide in the design of the new workflow. Although workflow repositories storing established workflows exist, searching such workflow repositories to find the most compatible (i.e., similar) established workflows can be difficult.

### SUMMARY

Disclosed herein are a method and a system for comparing established workflows against a workflow pattern to determine their degree of compatibility with this workflow pattern. Specifically, in the method and system, compatibility scores between established workflows, which can be stored in a workflow repository, and a workflow pattern, which can be for a new workflow under design, can be determined. To determine the compatibility score between a workflow pattern, which comprises first tasks, and an established workflow, which comprises second tasks, equivalent tasks in the established workflow can be identified. That is, any of the second tasks in the established workflow that are equivalent to any of the first tasks in the workflow pattern can be identified as equivalent tasks. Then, dependency matrices can be constructed for the first tasks in the workflow pattern and the equivalent tasks in the established workflow. These dependency matrices can be compared in order to identify any dependency relation matches in corresponding task pairs. Values can be assigned to the dependency relation matches and compatibility scores can be determined based on the sum of those values. The compatibility scores can be reported out to inform a user (e.g., a business process analyst) as to which of the previously established workflow(s) are the most compatible with the given workflow pattern so that, for example, they can optimally be used as design aid(s) for a new workflow.

More particularly, disclosed herein is a computer-implemented method for comparing established workflows against a workflow pattern to determine their degree of compatibility with the workflow pattern.

Specifically, the method can comprise accessing a workflow pattern. This workflow pattern can comprise a plurality of required tasks (referred to herein as first tasks) and dependencies (referred to herein as first dependencies and, particularly, first simple dependencies and/or first cyclical dependencies) between those required tasks. This workflow pattern can, for example, be generated based on user-submitted constraints for a process model.

The method can further comprise accessing multiple established workflows. Each established workflow can comprise a plurality of required tasks (referred to herein as second tasks) and dependencies (referred to herein as second dependencies and, particularly, second simple dependencies and/or second cyclical dependencies) between those required tasks. The established workflows can, for example, be stored in a workflow repository.

The method can further comprise determining compatibility scores between the workflow pattern and one or more of the established workflows. To determine the compatibility score between the workflow pattern and an established workflow, any equivalent tasks in the established workflow can be identified. That is, the second tasks in the established workflow can be compared to the first tasks in the workflow pattern and any of the second tasks in the established workflow that are equivalent to any of the first tasks in the workflow pattern can be identified as “equivalent tasks”. Next, a first dependency matrix and a second dependency matrix can be constructed for the workflow pattern and the established workflow, respectively. Specifically, the first dependency matrix can be constructed for the workflow pattern and can indicate first dependency relations between the first tasks in the workflow pattern. That is, the first dependency matrix can indicate first dependency relations between all possible pairs of first tasks in the workflow pattern. The second dependency matrix can be constructed for the established workflow and can indicate second dependency relations between the equivalent tasks only in the established workflow. That is, the second dependency matrix can indicate second dependency relations for all possible pairs of the equivalent tasks in the established workflow. A dependency relation can be any one of the following: “no dependency”, “simple dependency” or “cyclical dependency”.

To construct these dependency matrices, the following processes can be performed. For the first dependency matrix, any first backward cycle edges of any first cyclical dependencies between the first tasks in the workflow pattern can be identified and removed from consideration such that only first simple dependencies remain. Then, a preliminary first dependency matrix can be produced based on the remaining first simple dependencies. Finally, the first cyclical dependencies can be added into the preliminary first dependency matrix to construct the first dependency matrix for the workflow pattern. Similarly, for the second dependency matrix, any second backward cycle edges of any second cyclical dependencies between the equivalent tasks in the established workflow can be identified and removed from consideration such that only remaining second simple dependencies remain. Then, a preliminary second dependency matrix can be produced based on the remaining second simple dependencies. Finally, the second cyclical dependencies can be added into the preliminary second dependency matrix to construct the second dependency matrix for the established workflow.

Once the dependency matrices are constructed, they can be compared to each other in order to identify dependency relation matches in corresponding task pairs in the first dependency matrix and the second dependency matrix and the compatibility score between the established workflow and the workflow pattern can be determined based on the dependency relation matches. Specifically, match values can be assigned to the dependency relation matches and the compatibility score can be determined based on the sum of these match values.

Dependency relation matches can be simply defined as either an exact dependency relation match or no dependency relation match. In this case, a match value (e.g., 1) can be assigned to each exact dependency relation match and the sum of all match values assigned can be determined. The compatibility score can be based on this sum.

Alternatively, a more precise compatibility score can be determined by also taking into consideration dependency relation matches that are not exact. That is, the dependency relation matches can be defined as an exact dependency relation match, a partial dependency relation match (i.e., a non-exact dependency relation match) or no dependency relation match. In this case, a first match value can be assigned to each exact dependency relation match and a second match value, which is less than the first match value (i.e., a partial match value), can be assigned to each partial dependency relation match. The first match value can always be the same (e.g., 1) for all exact dependency relation matches. The second match value, however, can either always be the same (e.g., the same partial match value between 0 and 1) for all partial dependency relation matches or, alternatively, may vary depending upon the type of partial dependency relation match. That is, depending upon the type of partial dependency relation match, there may be one or more different second match values (i.e., one or more different partial values between 0 and 1) that could be assigned. The rationale for specifying different second match values is that there are degrees to which a dependency relation in the established workflow can be considered compatible with a dependency relation (or lack thereof) in the workflow pattern. Therefore, different partial match values can be assigned to reflect these differing degrees. Then, the sum of all first match values assigned to all exact dependency relation matches and all second match values assigned to all partial dependency relation matches can be determined. The compatibility score can be based on this sum.

Optionally, an even more precise compatibility score can be determined by taking into account the presence of non-equivalent tasks in the established workflow. Specifically, when the equivalent tasks in the established workflow are identified, non-equivalent tasks can also be identified and counted. Then, a total penalty value can be assigned based on this total number of non-equivalent tasks in the established workflow. For example, the total penalty value can be expressed as (e/n)², where e is the total number of the non-equivalent tasks in the established workflow and n is the total number of first tasks in the workflow pattern. In this case, the compatibility score can be determined based on the sum of all assigned match values and the total penalty value.

Once compatibility scores are determined for one or more established workflows, those established workflows can be ranked from a most compatible established workflow to a least compatible established workflow, based on the compatibility scores. Finally, a report indicating the ranking results and, particularly, indicating at least the most compatible can be generated and then output.

Also disclosed herein is a system for comparing established workflows against a given workflow pattern to determine their degree of compatibility with this pattern. The system can comprise at least a graphic user interface (GUI), a memory, which comprises a workflow repository, and at least one processor operatively connected to the graphic user interface (GUI) and memory.

In the system, the processor can access a workflow pattern and multiple established workflows. The workflow pattern can comprise a plurality of required tasks (referred to herein as first tasks) and dependencies (referred to herein as first dependencies and, particularly, first simple dependencies and/or first cyclical dependencies) between those required tasks. The workflow pattern can, for example, be generated based on user-submitted constraints for a process model. Each established workflow can comprise a plurality of required tasks (referred to herein as second tasks) and dependencies (referred to herein as second dependencies and, particularly, second simple dependencies and/or second cyclical dependencies) between those required tasks. The multiple established workflows can, for example, be stored in the workflow repository.

The processor can further determine compatibility scores between the workflow pattern and one or more of the established workflow. To determine the compatibility score between the workflow pattern and an established workflow, the processor can perform the following processes.

Specifically, to determine the compatibility score between the workflow pattern and an established workflow, the processor can identify any equivalent tasks in the established workflow. That is, the second tasks in the established workflow can be compared to the first tasks in the workflow pattern and any of the second tasks in the established workflow that are equivalent to any of the first tasks in the workflow pattern can be identified as “equivalent tasks”. Next, the processor can construct a first dependency matrix and a second dependency matrix for the workflow pattern and the established workflow, respectively. Specifically, the processor can construct the first dependency matrix so as to indicate first dependency relations between the first tasks in the workflow pattern. That is, the first dependency matrix can indicate first dependency relations between all possible pairs of first tasks in the workflow pattern. Additionally, the processor can construct the second dependency matrix so as to indicate second dependency relations between the equivalent tasks only in the established workflow. That is, the second dependency matrix can indicate second dependency relations for all possible pairs of the equivalent tasks in the established workflow. A dependency relation can be any one of the following: “no dependency”, “simple dependency” or “cyclical dependency”.

To construct these dependency matrices, the processor can perform the following processes. For the first dependency matrix, the processor can identify and remove from consideration any first backward cycle edges of any first cyclical dependencies between the first tasks in the workflow pattern such that only first simple dependencies remain. Then, the processor can produce a preliminary first dependency matrix based on the remaining first simple dependencies. Finally, the processor can add the first cyclical dependencies into the preliminary first dependency matrix to construct the first dependency matrix for the workflow pattern. Similarly, for the second dependency matrix, the processor can identify and remove from consideration any second backward cycle edges of any second cyclical dependencies between the equivalent tasks in the established workflow such that only remaining second simple dependencies remain. Then, the processor can produce a preliminary second dependency matrix based on the second simple dependencies. Finally, the processor can add the second cyclical dependencies into the preliminary second dependency matrix to construct the second dependency matrix for the established workflow.

The processor can further compare these dependency matrices (i.e., can compare the first dependency matrix to the second dependency matrix) in order to identify dependency relation matches in corresponding task pairs in the first dependency matrix and the second dependency matrix. Then, the processor can determine a compatibility score between the workflow pattern and the established workflow based on the dependency relation matches. Specifically, the processor can assign match values to the dependency relation matches and can determine the compatibility score based on the sum of the match values.

Dependency relation matches can be simply defined as either an exact dependency relation match or no dependency relation match. In this case, the processor can assign a match value (e.g., 1) to each exact dependency relation match. Then, the processor can determine the sum of all match values assigned and can further determine the compatibility score based on this sum.

Alternatively, a more precise compatibility score can be determined by taking dependency relation matches that are not exact. That is, the dependency relation matches can comprise an exact dependency relation match, a partial dependency relation match (i.e., a non-exact dependency relation match) or no dependency relation match. In this case, the processor can assign a first match value to each exact dependency relation match and a second match value, which is less than the first match value (i.e., a partial match value), to the partial dependency relation match(es). The first match value can always be the same (e.g., 1) for all exact dependency relation matches. The second match value, however, can either always be the same (e.g., the same partial match value between 0 and 1) for all partial dependency relation matches or, alternatively, the second match values may vary depending upon the type of partial dependency relation match. That is, depending upon the type of partial dependency relation match, the processor may assign one or more different second match values (i.e., one or more different partial values between 0 and 1). The rationale for specifying different second match values is that there are degrees to which a dependency relation in the established workflow can be considered compatible with a dependency relation (or lack thereof) in the workflow pattern. Therefore, different partial match values can be assigned to reflect these differing degrees. Therefore, different partial match values can be assigned to reflect these differing degrees. Then, the processor can determine the sum of all first match values assigned to all exact dependency relation matches and all second match values assigned to all partial dependency relation matches and can further determine the compatibility score based on this sum.

Optionally, an even more precise compatibility score can be determined by taking into account the presence of non-equivalent tasks in the established workflow. Specifically, when the processor identifies equivalent tasks in the established workflow, it can also identify and count non-equivalent tasks in the established workflow. Then, the processor can assign a total penalty value to the established workflow based on this total number of non-equivalent tasks. For example, the total penalty value can be expressed as (e/n)², where e is the total number of the non-equivalent tasks in the established workflow and n is the total number of first tasks in the workflow pattern. In this case, the processor can determine the compatibility score based on both the sum of assigned match values and the total penalty value.

Once the compatibility scores are determined for one or more established workflows, the processor can rank those established workflows from a most compatible established workflow to a least compatible established workflow, based on the compatibility scores. The processor can further generate a report that indicates the ranking results and, particularly, that indicates at least the most compatible of the established workflows. Finally, an output of the system can output the report.

Also disclosed herein is a computer program product. Specifically, disclosed is a non-transitory computer storage medium, which is readable by a computer system and which stores program instructions that are executable by the computer system to perform the above-described method for comparing established workflows against a workflow pattern to determine their degree of compatibility with this workflow pattern.

These and other features are described in, or are apparent from, the following detailed description.

### BRIEF DESCRIPTION OF THE DRAWINGS

Various exemplary systems and methods are described in detail below, with reference to the attached drawing figures, in which:

FIG. 1 is a flow diagram illustrating a method for comparing established workflows against a workflow pattern to determine their degree of compatibility with this workflow pattern;

FIG. 2 is a schematic diagram illustrating an exemplary workflow pattern;

FIG. 3 is a schematic diagram illustrating an exemplary established workflow;

FIG. 4 is a flow diagram illustrating exemplary steps that can be performed to determine a compatibility score between a workflow pattern and an established workflow;

FIG. 5A is a flow diagram illustrating exemplary steps that can be performed to construct a first dependency matrix for a workflow pattern;

FIG. 5B is a flow diagram illustrating exemplary steps that can be performed to construct a second dependency matrix for an established workflow;

FIG. 6 illustrates an exemplary preliminary first dependency matrix for a workflow pattern formed according to the flow diagram of FIG. 5A;

FIG. 7 illustrates an exemplary first dependency matrix for a workflow pattern formed according to the flow diagram of FIG. 5A;

FIG. 8 illustrates an exemplary preliminary second dependency matrix for an established workflow formed according to the flow diagram of FIG. 5B;

FIG. 9 illustrates an exemplary second dependency matrix for an established workflow formed according to the flow diagram of FIG. 5B;

FIG. 10 is an exemplary dependency relation match table illustrating different types of partial dependency relation matches;

FIG. 11 is an exemplary dependency relation match value assignment reference table;

FIG. 12 is a portion of an exemplary match value assignment table illustrating application of the reference table of FIG. 11 to assign a specific second match value to a specific corresponding task pair;

FIG. 13 is an exemplary match value assignment table illustrating assigned match values for dependency relation matches;

FIG. 14 is an illustration of an exemplary workflow pattern to established workflow compatibility report;

FIG. 15 is a schematic diagram illustrating a system for comparing established workflows against a workflow pattern to determine their degree of compatibility with this workflow pattern; and

FIG. 16 is a schematic diagram illustrating an exemplary computer hardware environment for implementing the disclosed method, system and computer program product.

### DETAILED DESCRIPTION

As mentioned above, Business Process Management (BPM) is an essential part of modern business wherein complex interactions between human and software systems are streamlined and automated. BPM encompasses a wide range of activities, including abstracting user-submitted process requirements (i.e., user-submitted constraints) for a process model into defined tasks (i.e., defined services) and further incorporating those defined tasks into defined workflows. Oftentimes, however, a business process analyst that engages in workflow design has only a limited knowledge (e.g., a high level knowledge or partial knowledge) of the various different tasks (i.e., the different services) required for a workflow, of the implementation of such tasks and/or of the composability of such tasks. Thus, it would be advantageous if the business process analyst could find similar previously established workflows (i.e., previously designed workflows that included at least some of the same tasks) to be used as a basis for designing the new workflow or in the refinement of an existing workflow. Although workflow repositories exist, searching such workflow repositories to find the most compatible (i.e., similar) established workflows can be difficult.

Disclosed herein are a method and a system for comparing established workflows against a workflow pattern to determine their degree of compatibility with this workflow pattern. Specifically, in the method and system, compatibility scores between established workflows, which can be stored in a workflow repository, and a workflow pattern, which can be for a new workflow under design, can be determined. To determine the compatibility score between a workflow pattern, which comprises first tasks, and an established workflow, which comprises second tasks, equivalent tasks in the established workflow can be identified. That is, any of the second tasks in the established workflow that are equivalent to any of the first tasks in the workflow pattern can be identified as equivalent tasks. Then, dependency matrices can be constructed for the first tasks in the workflow pattern and the equivalent tasks in the established workflow. These dependency matrices can be compared in order to identify any dependency relation matches in corresponding task pairs. Values can be assigned to the dependency relation matches and compatibility scores can be determined based on the sum of those values. The compatibility scores can be reported out to inform a user (e.g., a business process analyst) as to which of the previously established workflow(s) are the most compatible with the given workflow pattern so that, for example, they can optimally be used as design aid(s) for a new workflow.

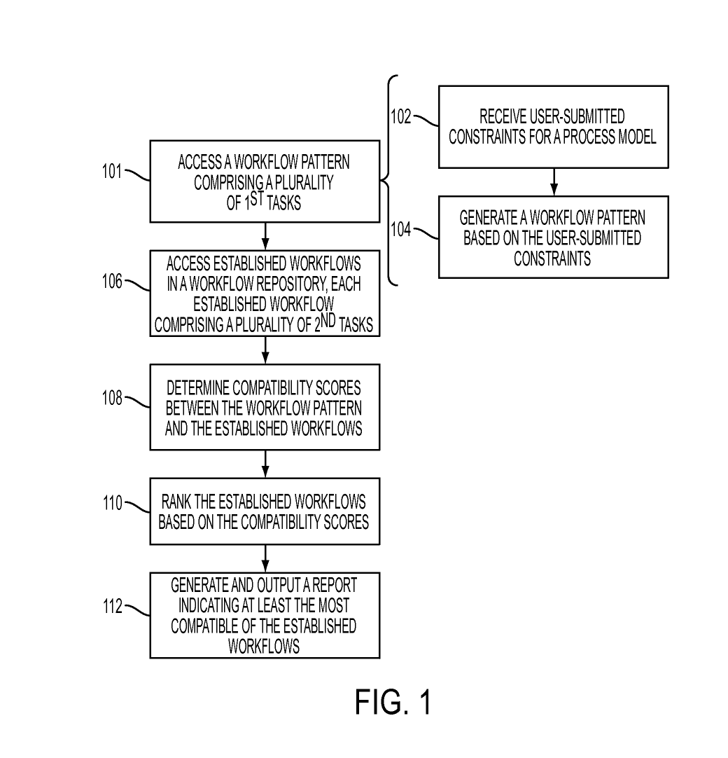

More particularly, referring to FIG. 1, disclosed is a method for comparing established workflows against a workflow pattern to determine their degree of compatibility with this workflow pattern.

This method can, for example, be used to identify previously established workflows (i.e., previously designed workflows) that can be used by a business process analyst to aide in the design of a new workflow. Alternatively, this method can be used in the refinement of an existing workflow, in the integration of multiple workflow repositories (e.g., to eliminate duplicates), or in any application that requires comparing one or more workflow patterns against a number of workflows.

In any case, this method can be computer-implemented. That is one or more of the processes described below can be performed by one or more components of a computer system. The computer-implemented method can begin by accessing a workflow pattern, which comprises a plurality of required tasks (referred to herein as first tasks) and dependencies (referred to herein as first dependencies and, particularly, first simple dependencies and/or first cyclical dependencies) between those required tasks (101).

For example, user-submitted constraints (i.e., user-submitted specifications, requests, demands, etc.) for a process model can be received (102) and, based on those constraints, a pattern for a new workflow (i.e., a workflow pattern) can be generated (104). This workflow pattern can be generated at process 104 such that it indicates, for the new workflow under design, the first tasks and first dependencies between those first tasks as set forth in the user-submitted constraints. Such a workflow pattern can, for example, be generated by a business process analyst using a graphic user interface (GUI) of a web-based graph editor tool on a computer system. Alternatively, any other technique for generating or acquiring a workflow pattern can be performed at process 101.

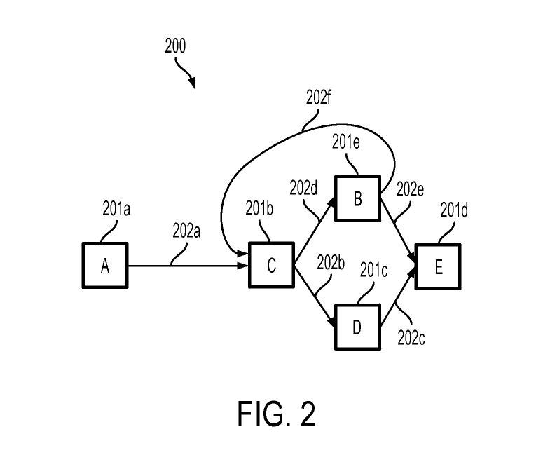

FIG. 2 shows an exemplary workflow pattern 200 (e.g., for a new workflow under design). This workflow pattern 200 comprises a plurality of first tasks 201a-e and a plurality of first edges 202a-f, which represent the first simple and cyclical dependencies between the first tasks 201a-e. Specifically, the first edges 202a-e in the workflow pattern 200 represent the following first simple dependencies within that workflow pattern 200: (1) first edge 202a indicates that first task 201b depends on the initial first task 201a; (2) first edge 202b indicates that first task 201c depends on first task 201b; (3) first edge 202c indicates that first task 201d depends on first task 201c; (4) first edge 202d indicates that first task 201e depends on first task 201b; and (5) first edge 202e indicates that first task 201d also dependents on first task 201e. This workflow pattern 200 also comprises a single first cyclical dependency with a first backward cycle edge 202f, wherein first task 201e depends on first task 201b and first task 201b depends on first task 201e.

Referring again to FIG. 1, the method can further comprise accessing multiple established workflows (i.e., previously designed workflows), which can be stored in a workflow repository (e.g., of a memory of a computer system) (106) and determining compatibility scores between the workflow pattern and one or more of the established workflows (108). Accessing the established workflows and determining the compatibility scores at process 106-108 can, for example, be performed in response to a search request to find compatible established workflows for the workflow pattern. This search request can, for example, be submitted by a business process analyst through the graphic user interface (GUI) of the web-based graph editor tool, as discussed above.

It should be noted that, like the workflow pattern, each established workflow can comprise a plurality of required tasks (referred to herein as second tasks) and dependencies (referred to herein as second dependencies and, particularly, second simple dependencies and/or second cyclical dependencies) between those required tasks.

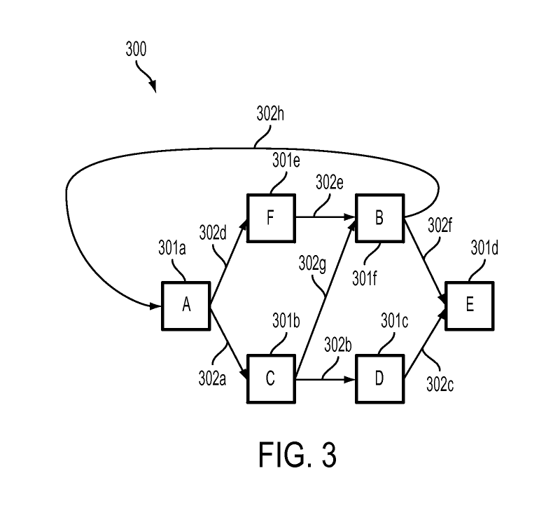

FIG. 3 shows one exemplary established workflow 300. This established workflow 300 comprises a plurality of second tasks 301a-f and a plurality of second edges 302a-g, which represent the second simple and cyclical dependencies between the second tasks 301a-f. Specifically, the second edges 302a-g show the following second simple dependencies within the established workflow 300: (1) second edge 302a indicates that second task 301b depends on second task 301a; (2) second edge 302b indicates that second task 301c depends on second task 301b; (3) second edge 302c indicates that second task 301d depends on second task 301c; (4) second edge 302d indicates that second task 301e depends on second task 301a; (5) second edge 302e indicates that second task 301f depends on second task 301e; (6) second edge 302f indicates that second task 301d depends on second task 301f; and (7) second edge 302g indicates that second task 301f depends on second task 301b. This established workflow 300 also comprises the following two second cyclical dependencies, which share the same second backward cycle edge 302f: (1) second task 301e depends on second task 301a, second task 301f depends on second task 301e, and second task 301a depends on second task 301f; and (2) second task 301b depends on second task 301a, second task 301f depends on second task 301b and second task 301a depends on second task 301f.

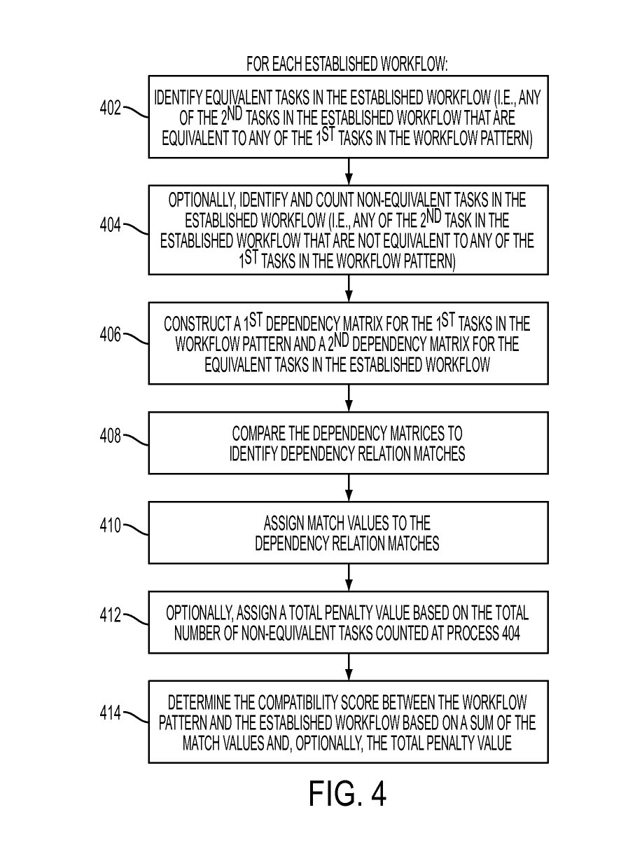

FIG. 4 is a flow diagram illustrating exemplary steps that can be performed at process 108 to determine a compatibility score between a workflow pattern (e.g., the workflow pattern 200 of FIG. 2) and an established workflow (e.g., the established workflow 300 of FIG. 3).

Specifically, referring to FIG. 4, any equivalent tasks in the established workflow 300 can be identified (402). That is, any of the second tasks 301a-f that are in the established workflow 300 and that are equivalent to any of the first tasks 201a-e in the workflow pattern 200 can be identified as “equivalent tasks”. Any of the second tasks 301a-f that are in the established workflow 300, but are not equivalent to any of the first tasks 201a-e in the workflow pattern 200 can be identified as “non-equivalent tasks”. Optionally, the total number of non-equivalent tasks in the established workflow 300 can also be counted (404) and subsequently used at process 412 as described in detail below to assign a total penalty value to the established workflow 300.

Various techniques are well known in the art for determining whether two tasks are essentially the same (i.e., for determining whether one task is equivalent to another task). For example, a method that combines a natural language processing method for comparing service names (i.e., task names) and descriptions and another method for comparing inputs and outputs between services (i.e., tasks) can be used to determine the similarity between two services (i.e., tasks) and, thereby to determine whether those two tasks are equivalent, as described in U.S. patent application Ser. No. 13/493,608 of Charif et al., filed on Jun. 11, 2012, assigned to Xerox Corporation and incorporated herein by references.

Such techniques can, for example, be used to determine that each of the following of the second tasks 301a-f in the established workflow 300 of FIG. 3 is an equivalent task with respect to a specific one of the first tasks 201a-e in the workflow pattern 200 of FIG. 2: (1) second task 301a in the established workflow 300 is an equivalent task with respect to first task 201a in the workflow pattern 200 because both are directed to the performance of the same TASK A; (2) second task 301f in established workflow 300 is an equivalent task with respect to first task 201e in the workflow pattern 200 because both are directed to the performance of the same TASK B; (3) second task 301b in the established workflow 300 is an equivalent task with respect to first task 201b in the workflow pattern 200 because both are directed to the performance of the same TASK C; (4) second task 301c in the established workflow 300 is an equivalent task with respect to first task 201c in the workflow pattern 200 because both are directed to the performance of the same TASK D; and (5) second task 301d in the established workflow 300 is an equivalent task with respect to first task 201d in the workflow pattern 200 because both are directed to the performance of the same TASK E. Such techniques can also be used to identify any non-equivalent tasks in the established workflow 300. In this case, second task 301e of the established workflow 300 is a non-equivalent task because it is directed to the performance of TASK F and none of the first tasks 201a-e of the workflow pattern 200 are directed to this same TASK F.

Next, referring again to FIG. 4, discrete dependency matrices can be constructed for the first tasks 201a-e in the workflow pattern 200 of FIG. 2 and for the equivalent tasks only in the established workflow 300 of FIG. 3 (406). Specifically, a first dependency matrix can be constructed for the first tasks 201a-e in the workflow pattern 200 of FIG. 2 in order to indicate first dependency relations between the TASKs A-E required in the workflow pattern 200. That is, the first dependency matrix can indicate first dependency relations between all possible pairs of first tasks in the workflow pattern. Additionally, a second dependency matrix can be constructed for only the previously identified equivalent tasks 301a-d and 301f (and not the non-equivalent task 301e) in the established workflow 300 of FIG. 3 in order to indicate second dependency relations between the same TASKs A-E required in the established workflow 300. That is, the second dependency matrix can indicate second dependency relations between all possible pairs of equivalent tasks only in the established workflow. It should be noted that in these dependency matrices any one of the following dependency relations can be shown for each task pairs (e.g., TASK A and TASK B, TASK A and TASK C, TASK A and TASK D, TASK A and TASK E, TASK B and TASK C, and so on): “no dependency”, “simple dependency” in one direction or the other, or “cyclical dependency” (i.e., dependency in both directions).

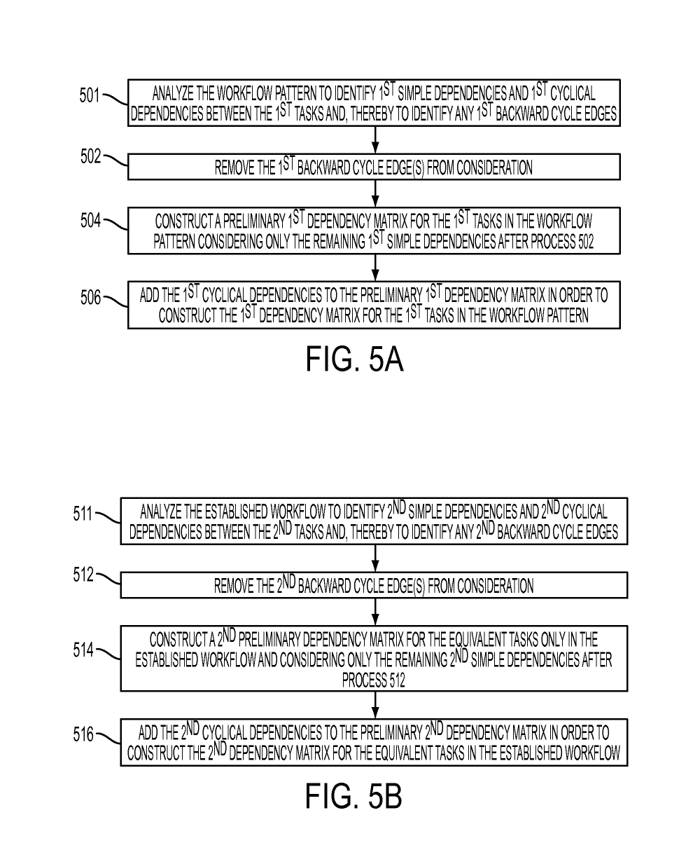

Referring to the flow diagrams of FIGS. 5A and 5B, the following steps can be performed at process 406 in order to construct the first dependency matrix for the first tasks 201a-e in the workflow pattern 200 and to construct the second dependency matrix for the equivalent tasks 301a-d and 301f in the established workflow 300.

Specifically, as illustrated in FIG. 5A, for the first dependency matrix, the workflow pattern 200 can be analyzed to identify any first simple dependencies and any first cyclical dependencies between the first tasks 201a-e (i.e., required TASKS A-E) in that workflow pattern 200 and, thereby to identify any first backward cycle edges of the first cyclical dependencies (501). For example, a single first cyclical dependency with a single first backward cycle edge 202f can be identified in the workflow pattern 200 between first task 201e (which is directed to the performance of TASK B) and first task 201b (which is directed to the performance of TASK C).

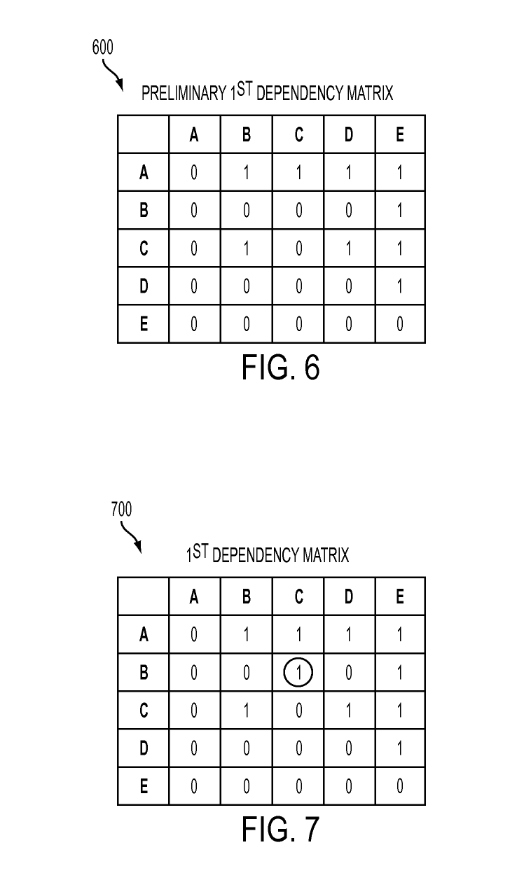

Next, any first backward cycle edges identified in the workflow pattern 200 at process 501 can be removed from consideration and the transitive closure of the resulting adjacency matrix can be calculated to determine a preliminary first dependency matrix (502)-(504). That is, the first backward cycle edge 202f can be removed from consideration such that only first simple dependencies remain. Then, at process 504, a preliminary first dependency matrix can be produced for the first tasks 201a-e, identified by name (i.e., TASKs A-E), based on the remaining first simple dependencies. For example, FIG. 6 illustrates an exemplary preliminary first dependency matrix 600 for the workflow pattern 200. As illustrated in this preliminary first dependency matrix 600, TASKs B-E depend on TASK A; TASK E depends on TASK B; TASKs B, D and E depend on TASK C; only TASK E depends on TASK D; and none of the TASKs A-D depend on TASK E. It should be noted that this preliminary first dependency matrix 600 should be constructed such that a dependency relation is distinguishable within the matrix from no dependency relation. For example, a “1” can indicate a dependency relation (i.e., a dependency of one task on another in a given direction) and a “0” can indicate no dependency relation (i.e., no dependency of on task on another in a given direction).

Finally, the first cyclical dependencies previously identified at process 501 can be added into the preliminary first dependency matrix 600 of FIG. 6 in order to construct the first dependency matrix for the first tasks 201a-e of the workflow pattern 200 (506). For example, FIG. 7 illustrates an exemplary first dependency matrix 700 for the workflow pattern 200. As illustrated in this first dependency matrix 700, the previously identified first cyclical dependency between TASK B and TASK C is added in, thereby showing that TASKs C and B are cyclically dependent. It should be noted that this first dependency matrix 700 can be similarly constructed such that a dependency relation is distinguishable within the matrix from no dependency relation. For example, a “1” can indicate a dependency relation (i.e., a dependency of one task on another in a given direction) and a “0” can indicate no dependency relation (i.e., no dependency of on task on another in a given direction). A cyclical dependency is apparent when dependency relations, as indicated by a “1”, are shown between two tasks in both directions. In this case, the preliminary first dependency matrix 600 of FIG. 6 shows TASK B being dependent upon TASK C but not vice versa, whereas the first dependency matrix 700 shows TASK C being dependent on TASK B and TASK B being dependent on TASK C.

As illustrated in FIG. 5B, for the second dependency matrix, the established workflow 300 can be analyzed to identify any second simple dependencies and any second cyclical dependencies between the equivalent tasks 301a-d and 301f (i.e., TASKS A-E) in that established workflow 300 and, thereby to identify any second backward cycle edges of the second cyclical dependencies (511). For example, two second cyclical dependencies that have a shared second backward cycle edge 302h can be identified: (1) a second cyclical dependency between second task 301a (which is directed to the performance of TASK A), second task 301e (which is directed to the performance of the TASK F, which is a non-equivalent task), and second task 301f (which is direct to the performance of TASK B); and (2) another second cyclical dependency between the second task 301a (again which is direct to the performance of TASK A), the second task 301b (which is directed to the performance of TASK C) and the second task 301f (again which is direct to the performance of TASK B).

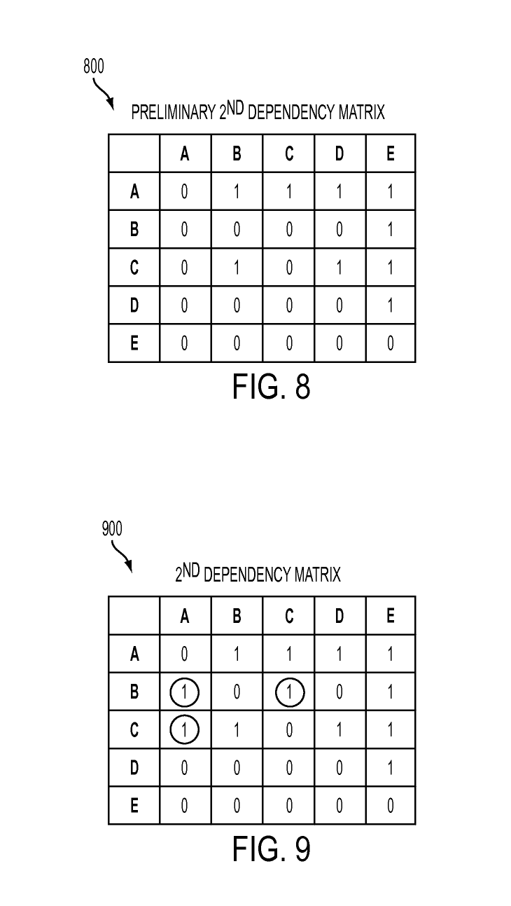

Next, any second backward cycle edges identified in the established workflow 300 at process 511 can be removed from consideration and the transitive closure of the resulting adjacency matrix can be calculated to determine a preliminary second dependency matrix (512)-(514). That is, at process 512, the second backward cycle edge 302h can be removed from consideration such that only second simple dependencies remain. Then, at process 514, a preliminary second dependency matrix can be produced for the previously identified equivalent tasks 301a-d and 301f, identified by name (i.e., TASKs A-E), based on the remaining second simple dependencies. For example, FIG. 8 illustrates an exemplary preliminary second dependency matrix 800 for the established workflow 300. As illustrated in this preliminary second dependency matrix 800, TASKs B-E depend on TASK A; TASK E depends on TASK B; TASKs B, D and E depend on TASK C; only TASK E depends on TASK D; and none of the TASKs A-D depend on TASK E. It should be noted that this preliminary second dependency matrix 800, like the preliminary first dependency matrix, should be constructed such that a dependency relation is distinguishable within the matrix from no dependency relation. For example, a “1” can indicate a dependency relation (i.e., a dependency of one task on another in a given direction) and a “0” can indicate no dependency relation (i.e., no dependency of on task on another in a given direction).

Finally, the second cyclical dependencies previously identified at process 511 can be added into the preliminary second dependency matrix 800 of FIG. 8 in order to construct the second dependency matrix for the equivalent tasks 301a-d and 301f of the established workflow 300 (516). For example, FIG. 9 illustrates an exemplary second dependency matrix 900 for the established workflow 300. As illustrated in this second dependency matrix 900, the previously identified second cyclical dependencies (e.g., between TASK A and TASK B without consideration of TASK F and between TASK A, TASK C, and TASK B) are added in. It should be noted that this second dependency matrix 900 can be similarly constructed such that a dependency relation is distinguishable within the matrix from no dependency relation. For example, a “1” can indicate a dependency relation (i.e., a dependency of one task on another in a given direction) and a “0” can indicate no dependency relation (i.e., no dependency of on task on another in a given direction). A cyclical dependency is apparent when dependency relations, as indicated by a “1”, are shown between two tasks in both directions. In this case, the preliminary second dependency matrix 800 of FIG. 8 shows TASK B being dependent upon TASK A but not vice versa, shows TASK C being dependent on TASK A but not vice versa, and TASK C being dependent on TASK B and not vice versa, whereas the second dependency matrix 900 shows TASK A being dependent on both TASK B and TASK C and TASK C also being dependent on TASK B.

Referring again to FIG. 4, once the dependency matrices are constructed at process 406, they can be compared to each other in order to identify dependency relation matches in corresponding task pairs in the first dependency matrix 700 and the second dependency matrix 900 (i.e., in corresponding cells in the dependency matrices) (408) and the compatibility score between the workflow pattern 200 of FIG. 2 and the established workflow 300 of FIG. 3 can be determined based on the dependency relation matches (410)-(414). More specifically, once the dependency matrices are constructed at process 406, they can be compared to each other in order to identify dependency relation matches in corresponding task pairs in the first dependency matrix 700 of FIG. 7 and the second dependency matrix 900 of FIG. 9 (i.e., in corresponding cells in the matrices) (408). Next, match values can be assigned to the dependency relation matches (410) and the compatibility score can be determined based on the sum of these match values (414).

At process 408, dependency relation matches can be simply defined as either an exact dependency relation match or no dependency relation match. Specifically, an exact dependency relation match can be when corresponding task pairs (e.g., TASK A and TASK B, TASK A and TASK C, TASK A and TASK D, TASK A and TASK E, TASK B and TASK C, and so on) in both directions in the first dependency matrix associated with the workflow pattern and in the second dependency matrix associated with the established workflow are exactly identical (e.g., 1-1:1-1, 0-0:0-0, 1-0:1-0, and 0-1:0-1). For example, in comparing the first dependency matrix 700 of FIG. 7 and the second dependency matrix 900 of FIG. 9: an exact dependency relation match exists for TASK B and TASK C because in both of these dependency matrices TASK B depends on TASK C and TASK C depends on TASK B (i.e., 1-1:1-1); an exact dependency relation match also exists for TASK D and TASK C because in both of these dependency matrices TASK D does not depend on TASK C and TASK C does not depend on TASK D (i.e., 0-0:0-0); an exact dependency relation match exists for TASK A and TASK D because in both of these dependency matrices TASK A does not depend on TASK D, but TASK D does not depend on TASK A (i.e., 0-1:0-1); and so on. Furthermore, no dependency relation match can be when corresponding task pairs in both directions in the first dependency matrix and the second dependency matrix are not identical (e.g., 1-1:0-0, 1-0:0-1, 0-1:1-0, 0-0:1-1, 1-1: 1-0, 1-1:0-1, 0-1:0-0, and 1-0:0-0).

In this case, at process 410, the same match value (e.g., a match value of 1) can be assigned to each exact dependency relation match. Finally, at process 414, the sum of all match values assigned can be determined and the compatibility score can be determined based on this sum.

Alternatively, a more precise compatibility score can be determined by also taking into consideration dependency relation matches that are not exact. That is, the dependency relation matches can comprise an exact dependency relation match, a partial dependency relation match (i.e., a non-exact dependency relation match) or no dependency relation match. Specifically, as described in detail above, an exact dependency relation match can be when corresponding task pairs (e.g., TASK A and TASK B, TASK A and TASK C, TASK A and TASK D, TASK A and TASK E, TASK B and TASK C, and so on) in both directions in the first dependency matrix associated with the workflow pattern and in the second dependency matrix associated with the established workflow are exactly identical (e.g., 1-1:1-1, 0-0:0-0, 1-0:1-0, and 0-1:0-1). Additionally, a partial dependency relation match can be when corresponding task pairs in the first dependency matrix and the second dependency matrix match in only one direction (e.g., 1-1: 1-0; 1-1:0-1, 0-1:0-0; 1-0:0-0). Finally, no dependency relation match can be when corresponding task pairs in both directions in the first dependency matrix and the second dependency matrix are completely different (e.g., 1-1:0-0, 1-0:0-1, 0-1:1:0, and 0-0:1-1).

In this case, at process 410, a first match value can be assigned to each exact dependency relation match and a second match value, which is different from and, particularly, which is less than the first match value (i.e., which is a partial match value), can be assigned to each partial dependency relation match. For each exact dependency relation match, the first match value assigned can always be the same first match value (e.g., 1). For partial dependency relation matches, the second match value assigned can always be the same second match value (e.g., the same partial match value between 0 and 1, such as 1/4, 1/3, 1/2, 2/3, 3/4, etc.). However, alternatively, the second match values assigned can vary depending upon the type of partial dependency relation match. That is, depending upon the type of partial dependency relation match, there may be one or more different second match values (i.e., one or more different partial values between 0 and 1) that could be assigned. The rationale for specifying different second match values is that there are degrees to which a dependency relation in the established workflow can be considered compatible with a dependency relation (or lack thereof) in the workflow pattern. Therefore, different partial match values can be assigned to reflect these differing degrees.

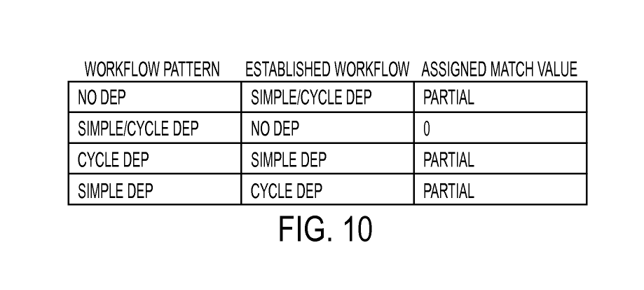

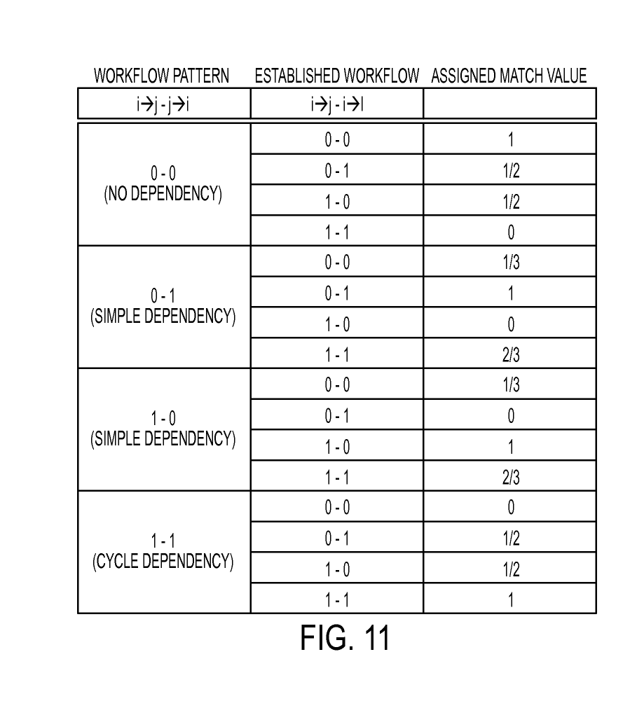

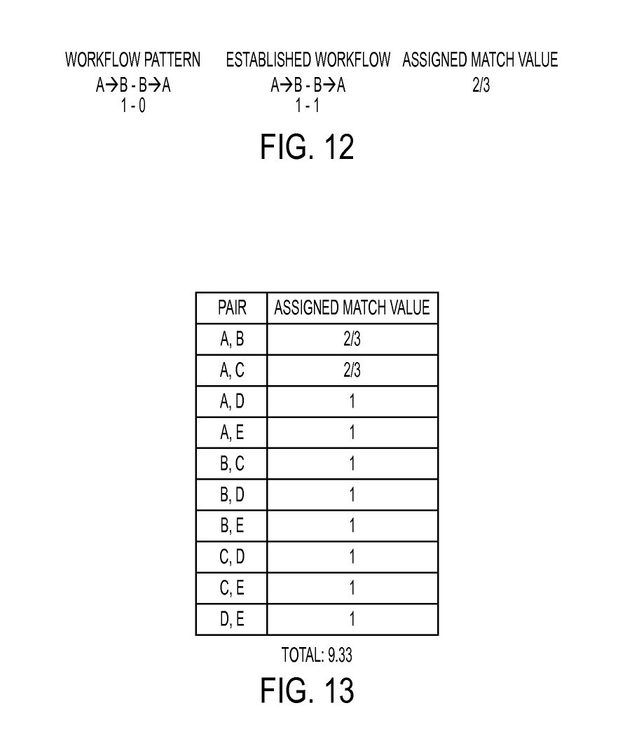

For example, FIG. 10 is a dependency relation match table illustrating different types of partial dependency relation matches that can be assigned second match values (i.e., partial match values) based on the perceived similarity in structure and logical task sequence of different dependency combinations. FIG. 11 is a dependency relation match value assignment reference table setting forth a first match value to be assigned to each exact dependency relation match and further setting forth multiple different second match values (i.e., multiple different partial match values) to be assigned to the different types of partial dependency relation matches following the principles of the dependency relation match table in FIG. 10. FIG. 12 is a portion of a match value assignment table illustrating the application of the reference table of FIG. 11 to assign a specific second match value (e.g., 2/3) to a specific corresponding task pair of TASK A and TASK B in the first dependency matrix 700 for the workflow pattern 200 as described above shown in FIG. 7 and second dependency matrix 900 for the established workflow 300 as described above and shown in FIG. 9.

Finally, at process 414, the sum of all first match values assigned to all exact dependency relation matches and all second match values (i.e., all partial match values) assigned to all partial relation matches can be determined and the compatibility score can be based on this sum.

Optionally, an even more precise compatibility score can be determined by taking into account the presence of non-equivalent tasks in the established workflow. Specifically, as mentioned above, when the equivalent tasks in the established workflow 300 are identified at process 402, any non-equivalent tasks can also be identified and counted (404). That is, any of the second tasks 301a-f that are in the established workflow 300 of FIG. 3 but are not equivalent to any of the first tasks 201a-e in the workflow pattern 200 of FIG. 2 can be identified as “non-equivalent tasks”. In this case, second task 301e of the established workflow 300 is a non-equivalent task because it is directed to the performance of TASK F and none of the first tasks 201a-e of the workflow pattern 200 are directed to this same TASK F. Then, a total penalty value can subsequently be assigned to the established workflow 300 based on the total number of non-equivalent tasks in the established workflow 300 and the total number of first tasks 201a-e in workflow pattern 200 (412). This total penalty value can, for example, be expressed as follows:

P=(e/n)² (1)

where P represents the total penalty value, e represents the total number of the non-equivalent tasks in the established workflow 300 and n represents the total number of tasks 201a-e in the workflow pattern 200. Alternatively, any other suitable technique for assigning a total penalty value (P) could be used. Then, at process 414, the compatibility score can be determined based on both the sum of the assigned match values as well as the total penalty value.

It should be noted that if the maximum match value that can be assign to corresponding tasks pairs (i.e., corresponding cells) in the first dependency matrix and second dependency matrix is one, then the maximum achievable compatibility score can be expressed as follows:

$${S}_{max} = ( \begin{matrix}n \\ 2\end{matrix} ) = \frac{n ( n - 1 )}{2} \qquad ( 2 )$$

where Sₘₐₓ represents the maximum achievable compatibility score between a workflow pattern and an established workflow and n represents the total number of first tasks in the workflow pattern.

Furthermore, the actual compatibility score of an established workflow with respect to a workflow pattern can be normalized based on the maximum achievable compatibility score and can be expressed at process 414 as follows:

$${S}_{actual} = \frac{Σ V - P}{{S}_{max}} \qquad ( 3 )$$

where S_{actual} represents the actual compatibility score between an established workflow and a workflow pattern, ΣV represents the sum of all match values assigned at process 410, and P represents any assigned penalty for non-equivalent tasks at process 412.

For example, FIG. 13 is a match value assignment table illustrating assigned match values for dependency relation matches in the corresponding task pairs in the first dependency matrix 700 as illustrated in FIG. 7 for the workflow pattern 200 of FIG. 2 and the second dependency matrix 900 as illustrated in FIG. 9 for the established workflow 300 of FIG. 3. In this case, the sum of all assigned match values ΣV is 9.33, the total penalty value (P) assigned using the formula (1) above would be 0.04 and the maximum achievable compatibility score (Sₘₐₓ) determined using the formula (2) above would be 10. Therefore, the compatibility score (S_{actual}) would be determined as follows:

$${S}_{actual} = \frac{9.33 - 0.04}{10} = 0.929$$

Referring again to FIG. 1, once compatibility scores are determined for multiple established workflows at process 108, those established workflows can be ranked (110). This ranking process 110 can comprise sorting the established workflows based on the compatibility scores from a most compatible established workflow (i.e., the established workflow with a compatibility score closest to the maximum achievable compatibility score T) to a least compatible established workflow (i.e., the established workflow with a compatibility score farthest from the maximum achievable compatibility score T).

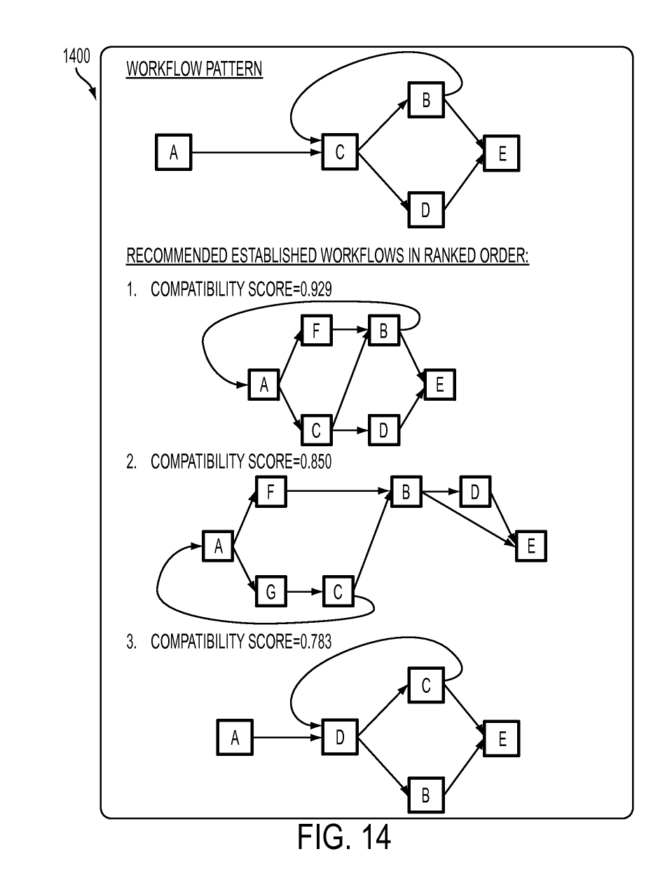

Then, as illustrated in FIG. 14, a report 1400 can be generated and output (e.g., displayed, printed, emailed, etc.) (112). This report 1400 can indicate the ranking results from process 110 and, particularly, can indicate at least the most compatible established workflow. Such a report will allow a business process analyst engaged in designing a new workflow to know which of the previously established workflow(s) in the workflow repository can optimally be used as workflow design aid(s).

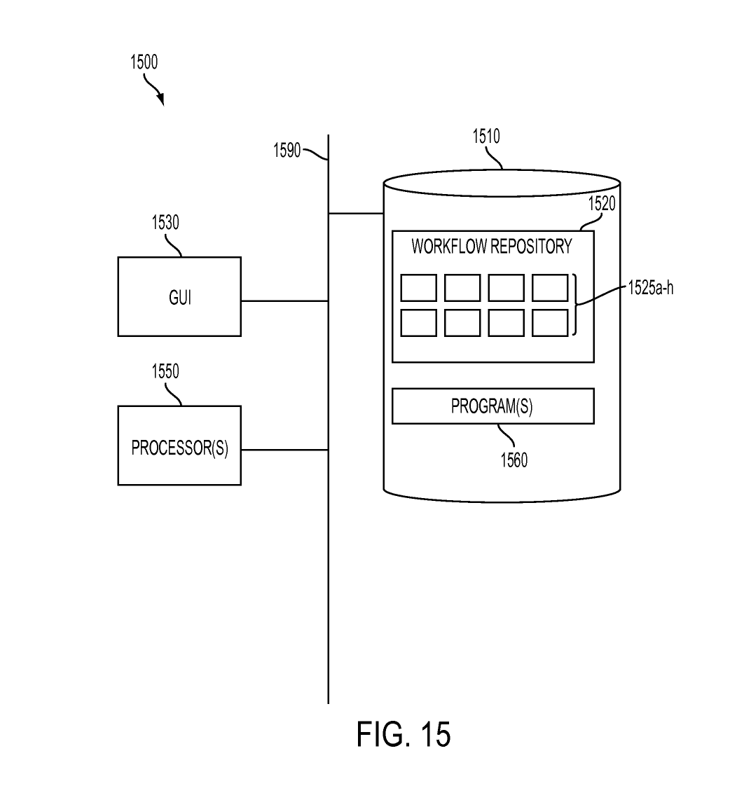

Referring to FIG. 15, also disclosed herein is a system 1500 for comparing established workflows against a workflow pattern to determine their degree of compatibility with this workflow pattern. This system 1500 can, for example, be used to identify previously established workflows (i.e., previously designed workflows) that can be used by a business process analyst to aide in the design of a new workflow. Alternatively, this method can be used in the refinement of an existing workflow, in the integration of multiple workflow repositories (e.g., to eliminate duplicates), or in any application that requires comparing one or more workflow patterns against a number of workflows.

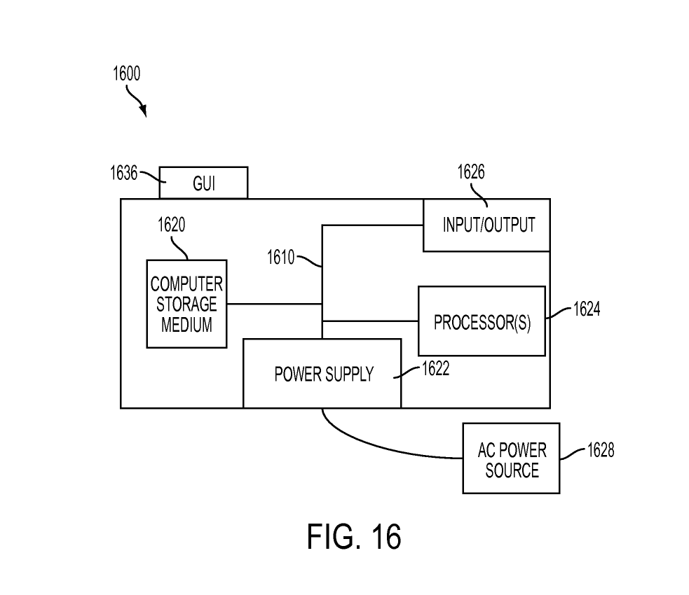

The system 1500 can be implemented, for example, in a computer hardware environment such as that described in detail below and depicted in FIG. 16. The system 1500 can comprise at least a graphic user interface (GUI) 1530, a memory 1510, which comprises a workflow repository 1520, and at least one processor 1550 operatively connected to the graphic user interface (GUI) 1530 and memory 1510 (e.g., over a system bus 1590 and/or a wired or wireless network connection).

In the system 1500, the processor 1550 can access a workflow pattern comprising a plurality of required tasks (referred to herein as first tasks) and dependencies (referred to herein as first dependencies and, particularly, first simple dependencies and/or first cyclical dependencies) between those required tasks. For example, a pattern for a new workflow (i.e., a workflow pattern) can be generated by a business process analyst based on user-submitted constraints for a process model and using the graphic user interface (GUI) 1530 in conjunction with a web-based graph editor tool 1540 (i.e., a program 1560 of instructions, which is stored in memory 1510 and which can be executed by the processor 1550 to produce a workflow pattern based on user inputs). Alternatively, any other suitable techniques can be used to generate or acquire the workflow pattern accessed by the processor 1550. As discussed in detail above with regard to the method, FIG. 2 shows an exemplary workflow pattern 200 for a new workflow under design. This workflow pattern 200 comprises a plurality of first tasks 201a-e and a plurality of first edges 202a-f, which represent the first simple and cyclical dependencies between the first tasks 201a-e.

The processor 1550 can further access multiple established workflows 1525a-h (i.e., previously designed workflows). These established workflows 1525a-h can, for example, be stored in the workflow repository 1520. It should be noted that, like the workflow pattern, each established workflow can comprise a plurality of required tasks (referred to herein as second tasks) and dependencies (referred to herein as second dependencies and, particularly, second simple dependencies and/or second cyclical dependencies) between those required tasks.

The processor 1550 can further determine (i.e., can be adapted to determine, can be configured to determine, can execute a program 1560 of instructions stored in memory 1510 to determine, etc.) compatibility scores between the workflow pattern and one or more of the established workflows 1525a-h. It should be noted that accessing the established workflows and determining the compatibility scores can be performed automatically by the processor 1550 in response to a search request to find compatible established workflows for the workflow pattern. This search request can, for example, be submitted by the business process analyst through the graphic user interface (GUI) 1530.

As discussed in detail above with regard to the method, FIG. 3 shows one exemplary established workflow 300. This established workflow 300 comprises a plurality of task 301a-f. As illustrated, this established workflow 300 comprises a plurality of second tasks 301a-f and a plurality of second edges 302a-g, which represent the second simple and cyclical dependencies between the second tasks 301a-f.

For purposes of illustration, the processes performed by the processor 1550 of determining a compatibility score between a workflow pattern and any given established workflow are described below with respect to the exemplary workflow pattern 200 of FIG. 2 and the exemplary workflow 300 of FIG. 3.

Specifically, the processor 1550 can identify (i.e., can be adapted to identify, can be configured to identify, can execute a program 1560 of instructions stored in memory 1510 to identify, etc.) any equivalent tasks in the established workflow 300. That is, the processor 1550 can compare all second tasks 301a-f in the established workflow 300 of FIG. 3 to all first tasks 201a-e in the workflow pattern 200 of FIG. 2 in order to identify as “equivalent tasks” any of the second tasks 301a-f that are in the established workflow 300 and that are equivalent to any of the first tasks 201a-e in the workflow pattern 200.

Optionally, the processor 1550 can also identify and count (i.e., can be adapted to identify and count, can be configured to identify and count, can execute a program 1560 of instructions stored in memory 1510 to identify and count, etc.) any non-equivalent tasks in the established workflow 300 of FIG. 3. The total number of non-equivalent tasks can subsequently be used as described in detail below to assign a total penalty value to the established workflow. Any of the second tasks 301a-f that are in the established workflow 300, but are not equivalent to any of the first tasks 201a-e in the workflow pattern 200 can be identified as “non-equivalent tasks”.

Various techniques are well known in the art for determining whether two tasks are essentially the same (i.e., for determining whether one task is equivalent to another task). For example, a method that combines a natural language processing method for comparing service names (i.e., task names) and descriptions and another method for comparing inputs and outputs between services (i.e., tasks) can be used to determine the similarity between two services (i.e., tasks) and, thereby to determine whether those two tasks are equivalent, as described in U.S. patent application Ser. No. 13/493,608 of Charif et al., filed on Jun. 11, 2012, assigned to Xerox Corporation and incorporated herein by references.

Such techniques can, for example, be used by the processor 1550 to determine that each of the following of the second tasks 301a-f in the established workflow 300 is an equivalent task with respect to a specific one of the first tasks 201a-e in the workflow pattern 200: (1) second task 301a in the established workflow 300 is an equivalent task with respect to first task 201a in the workflow pattern 200 because both are directed to the performance of the same TASK A; (2) second task 301f in established workflow 300 is an equivalent task with respect to first task 201e in the workflow pattern 200 because both are directed to the performance of the same TASK B; (3) second task 301b in the established workflow 300 is an equivalent task with respect to first task 201b in the workflow pattern 200 because both are directed to the performance of the same TASK C; (4) second task 301c in the established workflow 300 is an equivalent task with respect to first task 201c in the workflow pattern 200 because both are directed to the performance of the same TASK D; and (5) second task 301d in the established workflow 300 is an equivalent task with respect to first task 201d in the workflow pattern 200 because both are directed to the performance of the same TASK E. Such techniques can also be used to identify any non-equivalent tasks in the established workflow 300. In this case, second task 301e of the established workflow 300 is a non-equivalent task because it is directed to the performance of TASK F and none of the first tasks 201a-e of the workflow pattern 200 are directed to this same TASK F.

The processor 1550 can further construct (i.e., can be adapted to construct, can be configured to construct, can execute a program 1560 of instructions stored in memory 1510 to construct, etc.) a first dependency matrix for the first tasks 201a-e in the workflow pattern 200 of FIG. 2 and a second dependency matrix for the equivalent tasks only in the established workflow 300 of FIG. 3. Specifically, the processor 1550 can construct a first dependency matrix for the first tasks 201a-e in the workflow pattern 200 of FIG. 2 in order to indicate first dependency relations between the TASKs A-E required in the workflow pattern 200. That is, the first dependency matrix can indicate first dependency relations between all possible pairs of first tasks in the workflow pattern. Additionally, the processor 1550 can construct a second dependency matrix for only the previously identified equivalent tasks 301a-d and 301f (and not the non-equivalent task 301e) in the established workflow 300 of FIG. 3 in order to indicate second dependency relations between the same TASKs A-E required in the established workflow 300. That is, the second dependency matrix can indicate second dependency relations between all possible pairs of equivalent tasks only in the established workflow. It should be noted that in these dependency matrices any one of the following dependency relations can be shown for each task pairs (e.g., TASK A and TASK B, TASK A and TASK C, TASK A and TASK D, TASK A and TASK E, TASK B and TASK C, and so on): “no dependency”, “simple dependency” in one direction or the other, or “cyclical dependency” (i.e., dependency in both directions).

Specifically, for the first dependency matrix, the processor 1550 can analyze the workflow pattern 200 to identify any first simple dependencies and any first cyclical dependencies between the first tasks 201a-e (i.e., required TASKS A-E) in that workflow pattern 200 and, thereby to identify any first backward cycle edges of the first cyclical dependencies. For example, the processor 1550 can identify a single first cyclical dependency with a single first backward cycle edge 202f in the workflow pattern 200 between first task 201e (which is directed to the performance of TASK B) and first task 201b (which is directed to the performance of TASK C).

Next, the processor 1550 can remove from consideration any first backward cycle edges previously identified in the workflow pattern 200 and can calculate the transitive closure of the resulting adjacency matrix in order to determine a preliminary first dependency matrix. That is, the processor 1550 can remove the first backward cycle edge 202f from consideration such that only first simple dependencies remain. Then, the processor 1550 can produce a preliminary first dependency matrix for the first tasks 201a-e, identified by name (i.e., TASKs A-E), based on the remaining first simple dependencies. For example, as discussed in detail above with regard to the method, FIG. 6 illustrates an exemplary preliminary first dependency matrix 600 for the workflow pattern 200. As illustrated in this preliminary first dependency matrix 600, TASKs B-E depend on TASK A; TASK E depends on TASK B; TASKs B, D and E depend on TASK C; only TASK E depends on TASK D; and none of the TASKs A-D depend on TASK E. It should be noted that this preliminary first dependency matrix 600 should be constructed such that a dependency relation is distinguishable within the matrix from no dependency relation. For example, a “1” can indicate a dependency relation (i.e., a dependency of one task on another in a given direction) and a “0” can indicate no dependency relation (i.e., no dependency of on task on another in a given direction).

Finally, the processor 1550 can add any previously identified first cyclical dependencies into the preliminary first dependency matrix 600 of FIG. 6 in order to construct the first dependency matrix for the first tasks 201a-e of the workflow pattern 200. For example, as discussed in detail above with regard to the method, FIG. 7 illustrates an exemplary first dependency matrix 700 for the workflow pattern 200. As illustrated in this first dependency matrix 700, the previously identified first cyclical dependency between TASK B and TASK C is added in, thereby showing that TASKs C and B are cyclically dependent. It should be noted that this first dependency matrix 700 can be similarly constructed such that a dependency relation is distinguishable within the matrix from no dependency relation. For example, a “1” can indicate a dependency relation (i.e., a dependency of one task on another in a given direction) and a “0” can indicate no dependency relation (i.e., no dependency of on task on another in a given direction). A cyclical dependency is apparent when dependency relations, as indicated by a “1”, are shown between two tasks in both directions. In this case, the preliminary first dependency matrix 600 of FIG. 6 shows TASK B being dependent upon TASK C but not vice versa, whereas the first dependency matrix 700 shows TASK C being dependent on TASK B and TASK B being dependent on TASK C.

Additionally, for the second dependency matrix, the processor 1550 can analyze the established workflow 300 in order to identify any second simple dependencies and any second cyclical dependencies between the equivalent tasks 301a-d and 301f (i.e., TASKS A-E) in that established workflow 300 and, thereby to identify any second backward cycle edges of the second cyclical dependencies. For example, the processor 1550 can identify two second cyclical dependencies that have a shared second backward cycle edge 302h: (1) a second cyclical dependency between second task 301a (which is directed to the performance of TASK A), second task 301e (which is directed to the performance of the TASK F, which is a non-equivalent task), and second task 301f (which is direct to the performance of TASK B); and (2) another second cyclical dependency between the second task 301a (again which is direct to the performance of TASK A), the second task 301b (which is directed to the performance of TASK C) and the second task 301f (again which is direct to the performance of TASK B).

Next, the processor 1550 can remove any second backward cycle edges identified in the established workflow 300 from consideration and can calculate the transitive closure of the resulting adjacency matrix in order to determine a preliminary second dependency matrix. That is, the processor 1550 can remove the second backward cycle edge 302h from consideration such that only second simple dependencies remain. Then, the processor 1550 can produce a preliminary second dependency matrix for the previously identified equivalent tasks 301a-d and 301f, identified by name (i.e., TASKs A-E), based on the remaining second simple dependencies. For example, as discussed in detail above with regard to the method, FIG. 8 illustrates an exemplary preliminary second dependency matrix 800 for the established workflow 300. As illustrated in this preliminary second dependency matrix 800, TASKs B-E depend on TASK A; TASK E depends on TASK B; TASKs B, D and E depend on TASK C; only TASK E depends on TASK D; and none of the TASKs A-D depend on TASK E. It should be noted that this preliminary second dependency matrix 800, like the preliminary first dependency matrix, should be constructed such that a dependency relation is distinguishable within the matrix from no dependency relation. For example, a “1” can indicate a dependency relation (i.e., a dependency of one task on another in a given direction) and a “0” can indicate no dependency relation (i.e., no dependency of on task on another in a given direction).

Finally, the processor 1550 can add any previously identified second cyclical dependencies into the preliminary second dependency matrix 800 of FIG. 8 in order to construct the second dependency matrix for the equivalent tasks 301a-d and 301f of the established workflow 300. For example, as discussed in detail above with regard to the method, FIG. 9 illustrates an exemplary second dependency matrix 900 for the established workflow 300. As illustrated in this second dependency matrix 900, the previously identified second cyclical dependencies (e.g., between TASK A and TASK B without consideration of TASK F and between TASK A, TASK C, and TASK B) are added in. It should be noted that this second dependency matrix 900 can be similarly constructed such that a dependency relation is distinguishable within the matrix from no dependency relation. For example, a “1” can indicate a dependency relation (i.e., a dependency of one task on another in a given direction) and a “0” can indicate no dependency relation (i.e., no dependency of on task on another in a given direction). A cyclical dependency is apparent when dependency relations, as indicated by a “1”, are shown between two tasks in both directions. In this case, the preliminary second dependency matrix 800 of FIG. 8 shows TASK B being dependent upon TASK A but not vice versa, shows TASK C being dependent on TASK A but not vice versa, and TASK C being dependent on TASK B and not vice versa, whereas the second dependency matrix 900 shows TASK A being dependent on both TASK B and TASK C and TASK C also being dependent on TASK B.

Once the dependency matrices are constructed, the processor 1550 can compare (i.e., can be adapted to compare, can be configured to compare, can execute a program 1560 of instructions stored in memory 1510 to compare, etc.) them in order to identify dependency relation matches in corresponding task pairs in the first dependency matrix 700 of FIG. 7 and the second dependency matrix 900 of FIG. 9 (i.e., in corresponding cells in the dependency matrices). Next, the processor 1550 can assign (i.e., can be adapted to assign, can be configured to assign, can execute a program 1560 of instructions stored in memory 1510 to assign, etc.) match values to the dependency relation matches. Furthermore, once the match values are assigned, the processor 1550 can determine (i.e., can be adapted to determine, can be configured to determine, can execute a program 1560 of instructions stored in memory 1510 to determine, etc.) the compatibility score based on the sum of these match values.

Dependency relation matches can be simply defined as either an exact dependency relation match or no dependency relation match. Specifically, an exact dependency relation match can be when corresponding task pairs (e.g., TASK A and TASK B, TASK A and TASK C, TASK A and TASK D, TASK A and TASK E, TASK B and TASK C, and so on) in both directions in the first dependency matrix associated with the workflow pattern and in the second dependency matrix associated with the established workflow are exactly identical (e.g., 1-1:1-1, 0-0:0-0, 1-0:1-0, and 0-1:0-1). Furthermore, no dependency relation match can be when corresponding task pairs in both directions in the first dependency matrix and the second dependency matrix are not identical (e.g., 1-1:0-0, 1-0:0-1, 0-1:1-0, 0-0:1-1, 1-1: 1-0, 1-1:0-1, 0-1:0-0, and 1-0:0-0). In this case, the processor 1550 can assign the same match value (e.g., a match value of 1) to each exact dependency relation match. Finally, the processor 1550 can determine the sum of all match values assigned and can further determine the compatibility score between the workflow pattern 200 of FIG. 2 and the established workflow 300 of FIG. 3 based on this sum.

Alternatively, the processor 1550 can take into consideration dependency relation matches that are not exact to determine a more precise compatibility score. That is, the dependency relation matches can comprise an exact dependency relation match, a partial dependency relation match (i.e., a non-exact dependency relation match) or no dependency relation match. Specifically, as described in detail above, an exact dependency relation match can be when corresponding task pairs (e.g., TASK A and TASK B, TASK A and TASK C, TASK A and TASK D, TASK A and TASK E, TASK B and TASK C, and so on) in both directions in the first dependency matrix associated with the workflow pattern and in the second dependency matrix associated with the established workflow are exactly identical (e.g., 1-1:1-1, 0-0:0-0, 1-0:1-0, and 0-1:0-1). Additionally, a partial dependency relation match can be when corresponding task pairs in the first dependency matrix and the second dependency matrix match in only one direction (e.g., 1-1: 1-0; 1-1:0-1, 0-1:0-0; 1-0:0-0). Finally, no dependency relation match can be when corresponding task pairs in both directions in the first dependency matrix and the second dependency matrix are completely different (e.g., 1-1:0-0, 1-0:0-1, 0-1:1:0, and 0-0:1-1).

In this case, the processor 1550 can assign a first match value to each exact dependency relation match and a second match value, which is different from and, particularly, which is less than the first match value (i.e., which is a partial match value), to each partial dependency relation match. For each exact dependency relation match, the first match value assigned can always be the same first match value (e.g., 1). For partial dependency relation matches, the second match values assigned can always be the same second match values (e.g., the same partial match value between 0 and 1, such as 1/4, 1/3, 1/2, 2/3, 3/4, etc.). However, alternatively, the second match values assigned can vary depending upon the type of partial dependency relation match. That is, depending upon the type of partial dependency relation match, the processor 1550 can assign one or more different second match values (i.e., one or more different partial values between 0 and 1) to a given partial dependency relation match. The rationale for specifying different second match values is that there are degrees to which a dependency relation in the established workflow can be considered compatible with a dependency relation (or lack thereof) in the workflow pattern. Therefore, different partial match values can be assigned to reflect these differing degrees.

As discussed in detail above with regard to the method, FIG. 10 is a dependency relation match table illustrating different types of partial dependency relation matches that can be assigned second match values (i.e., partial match values) based on the perceived similarity in structure and logical task sequence of different dependency combinations. FIG. 11 is an dependency relation match value assignment reference table setting forth a first match value to be assigned to each exact dependency relation match and further setting forth multiple different second match values (i.e., multiple different partial match values) to be assigned to the different types of partial dependency relation matches following the principles of the dependency relation match table in FIG. 10. FIG. 12 is a portion of a match value assignment table illustrating the application of the reference table of FIG. 11 to assign a specific second match value (e.g., 2/3) to a specific corresponding task pair of TASK A and TASK B in the first dependency matrix 700 for the workflow pattern 200 as described above shown in FIG. 7 and second dependency matrix 900 for the established workflow 300 as described above and shown in FIG. 9.

Finally, the processor 1550 can determine the sum of all first match values assigned to all exact dependency relation matches and all second match values (i.e., all partial match values) assigned to all partial relation matches and can further determine the compatibility score for the established workflow 300 based on this sum.

Optionally, an even more precise compatibility score can be determined by taking into account the presence of any non-equivalent tasks in the established workflow 300. That is, as mentioned above, when the processor 1550 identifies the equivalent tasks in the established workflow, it can also identify and count any non-equivalent tasks. That is, the processor 1550 can identify, as “non-equivalent tasks”, any of the second tasks 301a-f that are in the established workflow 300 of FIG. 3 but are not equivalent to any of the first tasks 201a-e in the workflow pattern 200 of FIG. 2. In this case, second task 301e of the established workflow 300 is a non-equivalent task because it is directed to the performance of TASK F and none of the first tasks 201a-e of the workflow pattern 200 are directed to this same TASK F. Furthermore, the processor 1550 can assign (i.e., can be adapted to assign, can be configured to assign, can execute a program 1560 of instructions stored in memory 1510 to assign, etc.) a total penalty value based on the total number of non-equivalent tasks in the established workflow and the total number of first tasks 201a-e in the workflow pattern 200. This total penalty value can, for example, be expressed using the formula (1) discussed above with regard to the method. Alternatively, any other suitable technique for assigning a total penalty value (P) could be used. In this case, the processor 1550 can determine the compatibility score based on the sum of the assigned match values as well as the total penalty value using, for example, the formula (3) described in detail above with regard to the method.

Once the compatibility scores are determined for multiple established workflows, the processor 1550 can rank (i.e., can be adapted to rank, can be configured to rank, can execute a program 1560 of instructions stored in memory 1510 to rank, etc.) the established workflows based on the compatibility scores. Specifically, the processor 1550 can sort the established workflows based on the compatibility scores from a most compatible established workflow (i.e., the established workflow with a compatibility score closest to the maximum achievable compatibility score T) to a least compatible established workflow (i.e., the established workflow with a compatibility score farthest from the maximum achievable compatibility score T). Additionally, the processor 1550 can generate (i.e., can be adapted to generate, can be configured to generate, can execute a program 1560 of instructions stored in memory 1510 to generate, etc.) a report of the ranking results. Specifically, as described in detail above and illustrated in FIG. 14, this report 1400 can indicate the ranking results and, particularly, can indicate at least the most compatible established workflow. An output (e.g., a GUI, a printer, etc.) of the system 1500 can further output (e.g., display, print, email, etc.) the report. Such a report will allow a business process analyst engaged in designing a new workflow to know which of the previously established workflow(s) in the workflow repository can optimally be used as workflow design aid(s).

For illustration purposes, the system 1500, as described above as, refers to a processor that performs all of the above-described processes. However, it should be understood that the system 1500 may incorporate multiple processors and that the above-described processes may, alternatively, be performed by two or more of these processors.

Also disclosed herein is a computer program product. Specifically, disclosed is a non-transitory computer storage medium, which is readable by a computer system (e.g., the computer system of FIG. 16) and which stores program instructions that are executable by the computer system to perform the above-described method for searching a workflow repository to identify previously established workflows (i.e., previously designed workflows) that can be used by a business process analyst to aide in the design of a new workflow.

FIG. 16 illustrates a computer hardware environment and, particularly, a computerized device 1600, which can be used to implement the method, system and computer program disclosed herein. This computerized device 1600 can take the form of, for example, a server (e.g., a print server or other suitable server), a personal computer, a portable computing device, etc. The computerized device 1600 can comprise a non-transitory computer storage medium 1620, a communications port (e.g., an input/output device) 1626 and one or more processors (e.g., computer processing units) 1624 operatively connected to the storage medium 1620 and communications port 1626 (e.g., over a bus 1610). Optionally, the processor(s) 1624 can further be connected to an external computerized network (not shown). Additionally, the computerized device 1600 can comprise one or more accessory functional components, including a graphic user interface (GUI) assembly 1636, operatively connected to the processor(s) 1624 (e.g., over the bus 1610). The input/output device 1626 can provide communication to and from the computerized device 1600. The processor(s) 1624 can control the various actions of the computer system 1600. The storage medium device 1620 (which can be optical, magnetic, capacitor based, etc.) can store instructions (e.g., programs of instructions). These instructions can be readable the processor(s) 1624 and can be executed by the processor(s) 1624 to perform the various processes described above with regard to the method, system and computer program product disclosed herein. The various device components described above can operate on power supplied from a power supply 1622 connected to an external alternating current (AC) power source 1628. The power supply 1622 can comprise a power storage element (e.g., a battery), can connect to the external alternating current (AC) power source 1628, and can convert the external alternating current into the type of power needed by the various components.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the systems and methods described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well known and are not described in detail herein to keep this disclosure focused on the salient features presented. The systems and methods herein can encompass systems and methods that print in color, monochrome, or handle color or monochrome image data. All foregoing systems and methods are specifically applicable to electrostatographic and/or xerographic machines and/or processes.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements). Further, the terms automated or automatically mean that once a process is started (by a machine or a user), one or more machines perform the process without further input from any user.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

Disclosed above are a method and a system for comparing established workflows against a workflow pattern to determine their degree of compatibility with this workflow pattern. Specifically, in the method and system, compatibility scores between established workflows, which can be stored in a workflow repository, and a workflow pattern, which can be for a new workflow under design, can be determined. To determine the compatibility score between a workflow pattern, which comprises first tasks, and an established workflow, which comprises second tasks, equivalent tasks in the established workflow can be identified. That is, any of the second tasks in the established workflow that are equivalent to any of the first tasks in the workflow pattern can be identified as equivalent tasks. Then, dependency matrices can be constructed for the first tasks in the workflow pattern and the equivalent tasks in the established workflow. These dependency matrices can be compared in order to identify any dependency relation matches in corresponding task pairs. Values can be assigned to the dependency relation matches and compatibility scores can be determined based on the sum of those values. The compatibility scores can be reported out to inform a user (e.g., a business process analyst) as to which of the previously established workflow(s) are the most compatible with the given workflow pattern so that, for example, they can optimally be used as design aid(s) for a new workflow.

What is claimed is:

1. A method comprising:
accessing, by a computer system, multiple established workflows stored in a workflow repository; and
determining, by said computer system, a compatibility score between a workflow pattern and an established workflow in said workflow repository,
said workflow pattern comprising first tasks,
said established workflow comprising second tasks, and
said determining of said compatibility score comprising:
identifying as equivalent tasks any of said second tasks in said established workflow that are equivalent to any of said first tasks in said workflow pattern;
constructing a first dependency matrix for said workflow pattern and a second dependency matrix for said established workflow, said first dependency matrix indicating first dependency relations between all possible pairs of said first tasks and said second dependency matrix indicating second dependency relations for all possible pairs of said equivalent tasks;
comparing said first dependency matrix to said second dependency matrix to identify dependency relation matches in corresponding task pairs in said first dependency matrix and said second dependency matrix; and,
determining a compatibility score between said workflow pattern and said established workflow based on said dependency relation matches.

2. The method of claim 1, said workflow pattern being generated based on user-submitted constraints for a process model.

3. The method of claim 1, wherein a dependency relation comprises one of the following:
no dependency;
simple dependency; and
cyclical dependency.

4. The method of claim 1, said constructing of said first dependency matrix and said second dependency matrix comprising:
for said first dependency matrix, identifying and removing any first backward cycle edges of any first cyclical dependencies between said first tasks in said workflow pattern such that only first simple dependencies remain; producing a preliminary first dependency matrix based on said first simple dependencies; and adding said first cyclical dependencies into said preliminary first dependency matrix to construct said first dependency matrix for said workflow pattern; and
for said second dependency matrix, identifying and removing any second backward cycle edges of any second cyclical dependencies between said equivalent tasks in said established workflow such that only second simple dependencies remain; producing a preliminary second dependency matrix based on said second simple dependencies; and adding said second cyclical dependencies into said preliminary second dependency matrix to construct said second dependency matrix for said established workflow.

5. The method of claim 1,
said dependency relation matches each comprising any one of an exact dependency relation match and no dependency relation match, and
said determining of said compatibility score comprising:
assigning a match value to each exact dependency relation match; and
determining a sum of all match values assigned to all exact dependency relation matches.

6. The method of claim 1,
said dependency relation matches each comprising any one of an exact dependency relation match, a partial dependency relation match, and no dependency relation match, and
said determining of said compatibility score comprising:
assigning a first match value to each exact dependency relation match;
assigning a second match value to each partial dependency relation match, said first match value being greater than said second match value; and
determining a sum of all first match values assigned to all exact dependency relation matches and all second match values assigned to all partial dependency relation matches.

7. The method of claim 6, said exact dependency relation matches all having a same first match value and said partial dependency relation matches having different second match values based on type.

8. The method of claim 1, further comprising:
determining, by said computer system, compatibility scores between said workflow pattern and more than one of said established workflows; and
ranking, by said computer system, said established workflows from a most compatible to a least compatible based on said compatibility scores and outputting, by said computer system, a report indicating at least said most compatible.

9. A method comprising:
accessing, by a computer system, a multiple established workflows stored in a workflow repository; and
determining, by said computer system, a compatibility score between a workflow pattern and an established workflow in said workflow repository,
said workflow pattern comprising first tasks,
said established workflow comprising second tasks, and
said determining of said compatibility score comprising:
identifying as equivalent tasks any of said second tasks in said established workflow that are equivalent to any of said first tasks in said workflow pattern and further identifying as non-equivalent tasks any of said second tasks in said established workflow that are not equivalent to any of said first tasks in said workflow pattern;
constructing a first dependency matrix for said workflow pattern and a second dependency matrix for said established workflow, said first dependency matrix indicating first dependency relations between all possible pairs of said first tasks and said second dependency matrix indicating second dependency relations between all possible pairs of said equivalent tasks;
comparing said first dependency matrix to said second dependency matrix to identify dependency relation matches in corresponding task pairs in said first dependency matrix and said second dependency matrix;
assigning match values to said dependency relation matches;
assigning a total penalty value based on a total number of said non-equivalent tasks; and
calculating a compatibility score between said workflow pattern and said established workflow based on a sum of said match values less said total penalty value.

10. The method of claim 9, said constructing of said first dependency matrix and said second dependency matrix comprising:
for said first dependency matrix, identifying and removing any first backward cycle edges of any first cyclical dependencies between said first tasks in said workflow pattern such that only first simple dependencies remain; producing a preliminary first dependency matrix based on said first simple dependencies; and adding said first cyclical dependencies into said preliminary first dependency matrix to construct said first dependency matrix for said workflow pattern; and
for said second dependency matrix, identifying and removing any second backward cycle edges of any second cyclical dependencies between said equivalent tasks in said established workflow such that only second simple dependencies remain; producing a preliminary second dependency matrix based on said second simple dependencies; and adding said second cyclical dependencies into said preliminary second dependency matrix to construct said second dependency matrix for said established workflow.

11. The method of claim 9, said total penalty value being expressed as follows:
(e/n)², where e is said total number of said non-equivalent tasks in said established workflow and n is a total number of said first tasks in said workflow pattern.

12. The method of claim 9,
determining, by said computer system, compatibility scores between said workflow pattern and more than one of said established workflows; and
ranking, by said computer system, said established workflows from a most compatible to a least compatible based on said compatibility scores and outputting, by said computer system, a report indicating at least said most compatible.

13. A system comprising:
a memory comprising a workflow repository and multiple established workflows stored in said workflow repository; and
at least one processor in communication with said memory, accessing said workflow repository and determining a compatibility score between a workflow pattern and an established workflow, said workflow pattern comprising first tasks, said established workflow comprising second tasks and said compatibility score being determined by performing the following:
identifying as equivalent tasks any of said second tasks in said established workflow that are equivalent to said first tasks in said workflow pattern;
constructing a first dependency matrix for said workflow pattern and a second dependency matrix for said established workflow, said first dependency matrix indicating first dependency relations between all possible pairs of said first tasks and said second dependency matrix indicating second dependency relations for all possible pairs of said equivalent tasks;
comparing said first dependency matrix to said second dependency matrix to identify dependency relation matches in corresponding task pairs in said first dependency matrix and said second dependency matrix; and,
determining a compatibility score between said workflow pattern and said established workflow based on said dependency relation matches.

14. The system of claim 13, said workflow pattern being generated based on user-submitted constraints for a process model.

15. The system of claim 13, wherein a dependency relation comprises one of the following:
no dependency;
simple dependency; and
cyclical dependency.

16. The system of claim 13, said constructing of said first dependency matrix and said second dependency matrix comprising:
for said first dependency matrix, identifying and removing any first backward cycle edges of any first cyclical dependencies between said first tasks in said workflow pattern such that only first simple dependencies remain; producing a preliminary first dependency matrix based on said first simple dependencies; and adding said first cyclical dependencies into said preliminary first dependency matrix to construct said first dependency matrix for said workflow pattern; and
for said second dependency matrix, identifying and removing any second backward cycle edges of any second cyclical dependencies between said equivalent tasks in said established workflow such that only second simple dependencies remain; producing a preliminary second dependency matrix based on said second simple dependencies; and adding said second cyclical dependencies into said preliminary second dependency matrix to construct said second dependency matrix for said established workflow.

17. The system of claim 13,
said dependency relation matches each comprising any one of an exact dependency relation match and no dependency relation match, and
said determining of said compatibility score comprising:
assigning a match value to each exact dependency relation match; and
determining a sum of all match values assigned to all exact dependency relation matches.

18. The system of claim 13,
said dependency relation matches each comprising any one of an exact dependency relation match, a partial dependency relation match, and no dependency relation match, and
said determining of said compatibility score comprising:
assigning a first match value to each exact dependency relation match;
assigning a second match value to each partial dependency relation match, said first match value being greater than said second match value; and
determining a sum of all first match values assigned to all exact dependency relation matches and all second match values assigned to all partial dependency relation matches.

19. The system of claim 18, said exact dependency relation matches all having a same first match value and said partial dependency relation matches having different second match values based on type.

20. The system of claim 13, said at least one processor further assigning a total penalty value based on a total number of non-equivalent tasks in said established workflow and further determining said compatibility score based on said total penalty value.

21. The system of claim 20, said total penalty value being expressed as follows:
(e/n)², where e is said total number of said non-equivalent tasks in said established workflow and n is a total number of said first tasks in said workflow pattern.

22. The system of claim 13,
said at least one processor further determining compatibility scores between said workflow pattern and more than one of said established workflows and further ranking said established workflows from a most compatible to a least compatible based on said compatibility scores, and
said system further comprising an output outputting a report indicating at least said most compatible.

23. A non-transitory computer storage medium readable by a computer system, said non-transitory computer storage medium storing instructions executable by said computer system to perform a method, said method comprising:
accessing multiple established workflows stored in a workflow repository; and
determining a compatibility score between a workflow pattern and an established workflow in said workflow repository,
said workflow pattern comprising first tasks,
said established workflow comprising second tasks, and
said determining of said compatibility score comprising:
identifying as equivalent tasks any of said second tasks in said established workflow that are equivalent to any of said first tasks in said workflow pattern;
constructing a first dependency matrix for said workflow pattern and a second dependency matrix for said established workflow, said first dependency matrix indicating first dependency relations between all possible pairs of said first tasks and said second dependency matrix indicating second dependency relations for all possible pairs of said equivalent tasks;
comparing said first dependency matrix to said second dependency matrix to identify dependency relation matches in corresponding task pairs in said first dependency matrix and said second dependency matrix; and
determining a compatibility score between said workflow pattern and said established workflow based on said dependency relation matches.
